(19) United States
(12) Patent Application Publication
(10) Pub. No.: US 2026/0230395 A1
(43) Pub. Date: Aug. 6, 2026

(54) ARTIFICIAL INTELLIGENCE/MACHINE LEARNING (AI/ML) IN WIRELESS COMMUNICATIONS

(71) Applicant: Lenovo (United States) Inc., Morrisville, NC (US)

(72) Inventors: Tapisha Soni, Munich (DE); Abdul Rasheed Mohammed, Hyderabad (IN); Joachim Löhr, Wiesbaden (DE); Vahid Pourahmadi, München (DE)

(73) Assignee: Lenovo (United States) Inc., Morrisville, NC (US)

(21) Appl. No.: 19/047,501

(22) Filed: Feb. 6, 2025

(51) Int. Cl. H04L 41/16; H04W 76/27

(52) U.S. Cl. CPC H04L 41/16; H04W 76/27

(57) ABSTRACT

Various aspects of the present disclosure relate to artificial intelligence/machine learning (AI/ML) in wireless communications. A user equipment (UE) can generate an indication associated with an AI/ML model, where the indication includes information of AI/ML model functionality available at the UE, and transmit the indication associated with the AI/ML model. In implementations, a UE can generate an indication associated with AI/ML model transfer, where the indication includes information of one or more AI/ML model transfer settings of the UE, and transmit the indication associated with the AI/ML model transfer.

### TECHNICAL FIELD

The present disclosure relates to wireless communications, and more specifically to machine learning and artificial intelligence in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to generate an indication associated with an artificial intelligence/machine learning (AI/ML) model, where the indication includes information of AI/ML model functionality available at the UE; and transmit the indication associated with the AI/ML model.

A processor (e.g., a standalone processor chipset, or a component of a UE) for wireless communication is described. The processor may be configured to, capable of, or operable to perform one or more operations as described herein. For example, the processor may be configured to, capable of, or operable to generate an indication associated with an AI/ML model, where the indication includes information of AI/ML model functionality available at the UE; and transmit the indication associated with the AI/ML model.

A method performed or performable by a UE for wireless communication is described. The method may include generating an indication associated with an AI/ML model, where the indication includes information of AI/ML model functionality available at the UE; and transmitting the indication associated with the AI/ML model.

In some implementations of the UE, the processor, and the method described herein, the indication is transmitted based at least in part on a request for AI/ML functionality of the UE.

In some implementations of the UE, the processor, and the method described herein, the indication is transmitted based at least in part on a Subscriber Identity Module (SIM) status of the UE, where the SIM status corresponds to a change in an active SIM from a first SIM of the UE to a second SIM of the UE.

In some implementations of the UE, the processor, and the method described herein, the indication is transmitted based at least in part on a change in radio resource control (RRC) state.

In some implementations of the UE, the processor, and the method described herein, the indication is transmitted via a RRC message.

In some implementations of the UE, the processor, and the method described herein, indication is transmitted via UE assistance information (UAI).

A UE for wireless communication is described. The UE may be configured to, capable of, or operable to perform one or more operations as described herein. For example, the UE may be configured to, capable of, or operable to generate an indication associated with AI/ML model transfer, where the indication includes information of one or more AI/ML model transfer settings of the UE; and transmit the indication associated with the AI/ML model transfer.

A processor (e.g., a standalone processor chipset, or a component of a UE) for wireless communication is described. The processor may be configured to, capable of, or operable to perform one or more operations as described herein. For example, the processor may be configured to, capable of, or operable to generate an indication associated with AI/ML model transfer, where the indication includes information of one or more AI/ML model transfer settings of the UE; and transmit the indication associated with the AI/ML model transfer.

A method performed or performable by a UE for wireless communication is described.

The method may include generating an indication associated with AI/ML model transfer, where the indication includes information of one or more AI/ML model transfer settings of the UE; and transmitting the indication associated with the AI/ML model transfer.

In some implementations of the UE, the processor, and the method described herein, the indication is transmitted based at least in part on a request for the one or more AI/ML model transfer settings of the UE.

In some implementations of the UE, the processor, and the method described herein, the request includes options to accept AI/ML model transfer, reject AI/ML model transfer, or suspend AI/ML model transfer.

In some implementations of the UE, the processor, and the method described herein, the indication includes an indication to accept AI/ML model transfer, and in the UE, the processor, and the method described herein, the UE, the processor, and the method may further be configured to, capable of, operable to, performed to, or performable to receive an AI/ML model transfer configuration.

In some implementations of the UE, the processor, and the method described herein, the one or more AI/ML model transfer settings include an indication of one or more connection types for AI/ML model transfer to the UE.

In some implementations of the UE, the processor, and the method described herein, the indication of the one or more connection types includes an indication to use, for AI/ML model transfer to the UE, one of a first SIM connection, a second SIM connection, or a non-3GPP wireless connection.

In some implementations of the UE, the processor, and the method described herein, the AI/ML model transfer indication is transmitted based at least in part on one or more of a configuration associated with AI/ML model transfer; a SIM status of the UE, where the SIM status corresponds to a change in an active SIM from a first SIM of the UE to a second SIM of the UE; or a change in RRC state.

An NE (e.g., a base station) for wireless communication is described. The NE may be configured to, capable of, or operable to perform one or more operations as described herein. For example, the NE may be configured to, capable of, or operable to transmit a request for one or more AI/ML model transfer settings of a UE; and receive an indication associated with AI/ML model transfer, where the indication includes the one or more AI/ML model transfer settings of the UE.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a request for one or more AI/ML model transfer settings of a UE; and receive an indication associated with AI/ML model transfer, where the indication includes the one or more AI/ML model transfer settings of the UE.

A method performed or performable by an NE (e.g., a base station) for wireless communication is described. The method may include to transmitting a request for one or more AI/ML model transfer settings of a UE; and receiving an indication associated with AI/ML model transfer, where the indication includes the one or more AI/ML model transfer settings of the UE.

In some implementations of the NE, the processor, and the method described herein, the request includes options to accept AI/ML model transfer, reject AI/ML model transfer, or suspend AI/ML model transfer.

In some implementations of the NE, the processor, and the method described herein, the indication of the one or more AI/ML model transfer settings of the UE includes one of a first setting to accept AI/ML model transfer, a second setting to reject AI/ML model transfer, or a third setting to suspend AI/ML model transfer.

In some implementations of the NE, the processor, and the method described herein, the indication includes a first setting to accept AI/ML model transfer, and in the NE, the processor, and the method described herein, the NE, the processor, and the method may further be configured to, capable of, operable to, performed to, or performable to transmit a notification configured to enable the UE to obtain one or more AI/ML models, where the notification includes one or more of: the one or more AI/ML models; or an instruction for obtaining the one or more AI/ML models.

In some implementations of the NE, the processor, and the method described herein, the notification is transmitted via one of control plane signaling or user plane signaling.

In some implementations of the NE, the processor, and the method described herein, the one or more AI/ML model transfer settings include an indication of one or more connection types for AI/ML model transfer to the UE; and the indication of the one or more connection types includes an indication to use, for AI/ML model transfer to the UE, one of a first operator SIM connection, a second operator SIM connection, or a non-3GPP connection, where the notification is transmitted via a selected connection type of the one or more connection types.

### BRIEF DESCRIPTION OF THE DRAWINGS

FIG. 1 illustrates an example of a wireless communications system in accordance with aspects of the present disclosure.

FIG. 2 and FIG. 3 illustrate example systems for one sided AI/ML models.

FIG. 4 illustrates an example system for a two sided model.

FIG. 5 illustrates an example system in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. Wireless communications systems can utilize AI/ML for a variety of different purposes, such as for network operation, network optimization, automated processing (e.g., self-driving cars in vehicle to everything (V2X) scenarios), network planning, security information and event management (SIEM)), etc. AI/ML can leverage AI/ML models (e.g., machine learning models or neural network models, which may be referred to herein as “models” and “AI/ML functionality”) which represent programs and/or algorithms trained on a set of data to provide outputs, such as to recognize patterns, make decisions, generate content, etc. AI models, for instance, can apply different algorithms to data inputs to provide data output for performing different tasks.

AI/ML models in wireless communications systems can be implemented in a variety of configurations. For instance, models can be implemented at a transmitter, a receiver, or both. For instance, a model can be trained and implemented at the UE side, NE side, or at both UE and NE sides. For example, a two sided model represents an AI/ML model that includes AI/ML functionality at both the UE and NE sides. Implementing a two sided model involves a number of challenges, such as identifying encoder-decoder pairs that enable cooperation between the UE and the NE. Additionally, such challenges include generating and maintaining training data that can maintain cooperative functionality between different sides of a two sided AI/ML model. Different methods are available to train and update models of two-sided models (e.g., neural network (NN) modules of a two-sided model), including centralized training, simultaneous training, and separate training. Each of these approaches may involve different levels of inter-entity (e.g., inter-vendor) cooperation. Several schemes may be implemented to reduce the complexity of inter-entity collaboration but some of these schemes may result in performance degradation of resulting two-sided models.

Aspects of the present disclosure are described in the context of a wireless communications system, and include implementations that provide for model transfer and delivery, coordination and signaling for indicating information corresponding to models available at the UE, and model transfer and delivery in Dual-SIM/Muli-SIM (MUSIM) scenarios. For model transfer and delivery to a UE from an NE (e.g., network, UE-server, over the top (OTT)-server), model transfer solutions are described via user plane signaling which can be initiated by the NE and/or based on acknowledgment from the UE. A control plane solution is also described which allows model transfer to be performed directly via downlink transmission. For coordination and signaling for indicating information corresponding to models available at the UE, a UE can send an indication (e.g., model availability indication) about available models at the UE to the NE. The indication, for example, may include information about the available models at the UE such as the model ID, a version number of the available model, and associated ID(s). For model transfer and delivery in MUSIM scenarios, implementations enable selecting and assigning an operator to transfer the AI/ML model to the UE. A user can be provided with options for AI/ML-related downloads by extending the menu settings or settings to enable/disable AI/ML-related downloads.

By performing the described techniques, a device in a wireless communications system can utilize AI/ML models and associated functionality to perform different wireless communication tasks, while decreasing signaling overhead associated with enabling AI/ML functionality.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

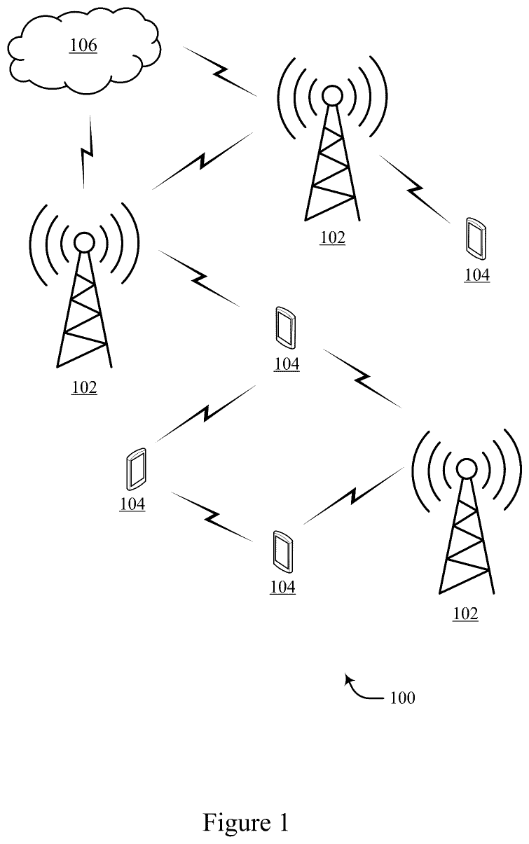

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 generates an indication associated with an AI/ML model, where the indication includes information of AI/ML model functionality available at the UE, and transmits the indication associated with the AI/ML model. In another example, the UE 104 generates an indication associated with AI/ML model transfer, where the indication includes information of one or more AI/ML model transfer settings of the UE, and transmits the indication associated with the AI/ML model transfer.

An NE 102 (e.g., a base station, gNB) transmits a request for one or AI/ML model transfer settings of a UE, and receives an indication associated with AI/ML model transfer, where the indication includes the one or more AI/ML model transfer settings of the UE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Several schemes have been proposed to use machine learning models for wireless communications to reduce overhead, improve performance, or reduce latency of a communication link. For example, AI/ML models for CSI feedback compression, Modulation/demodulation, scheduling, interference management, and Positioning.

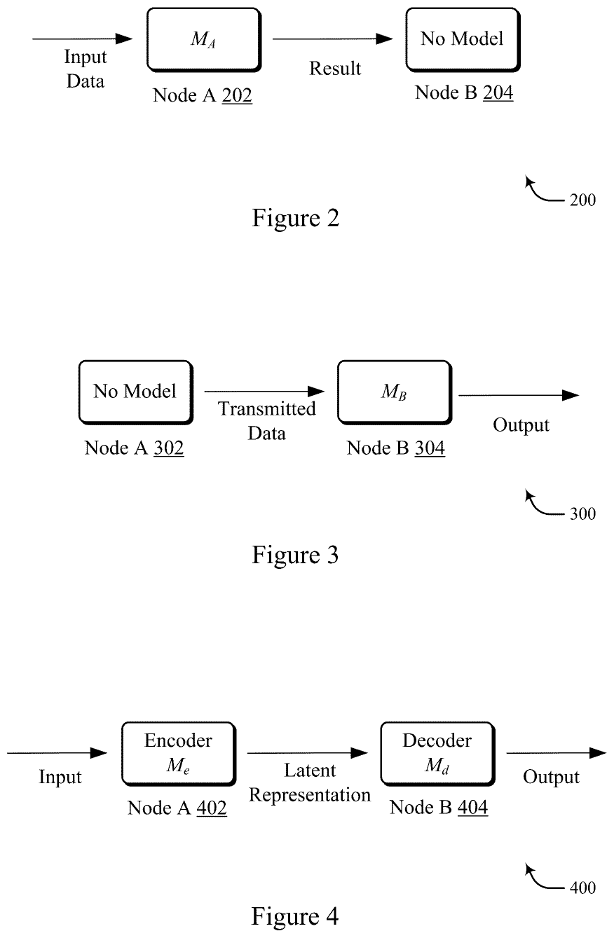

FIG. 2 and FIG. 3 illustrate example systems 200, 300 for one sided AI/ML models. In the system 200, the AI/ML model is located at a Node A 202 (e.g., M_{A}) and a Node B 204 does not include an AI/ML model. In the system 300, a Node A 302 does not include an AI/ML model, and a Node B 304 (e.g., M_{A}) includes an AI/ML model. In the systems 200, 300, Node A and Node B can be either a NE or a UE. The systems 200, 300 can be implemented for various purposes, such as beam management, CSI prediction, RRM measurement prediction, radio link failure prediction, handover failure prediction, positioning, etc. Based on where AI/ML inference occurs, a model can be called a UE side model when the UE performs the inference whereas for a NE side model, the inference is performed by the NE.

FIG. 4 illustrates an example system 400 for a two sided model. In the system 400, one part of the AI/ML model is located at a Node A 402 and other part is located at a Node B 404. In the system 400, for example, the Node A 402 is referred to as Mₑ(encoding model) and the Node B 404 is referred to as M_{d}(decoding model). This arrangement is just one example, and the location of the encoder and decoder can be alternated. A two sided model can reduce feedback information, where an encoding part (e.g., at the UE) computes a quantized latent representation of the input data, and the decoding part (at the NE) obtains a latent representation and uses the latent representation to reconstruct output. The input data can be a dataset which is based on the channel measurements. For example, the input data can be raw channel inputs of H^{k} or Hₗ^{k}, or for example the precoders that are computed from the channel matrix, e.g., the eigenvector associated with the largest eigen-vector of H^{k} for each subband.

AI/ML models for a given use case may be tailored toward and applicable to specific scenarios, configurations, locations, and deployments, among other factors. AI/ML models may undergo updates, such as model changes, as part of their development. After training the models, there can be multiple models (at Node A side), associated with different Node B's, and multiple models (at Node B side) associated with different Node A's. The design and optimization of the procedures and ML models can be use-case dependent. Training, updating, fine tuning, and monitoring of AI/ML models can be based on data collected from the environment.

Minimization of drive tests (MDT) is a feature introduced by the 3rd Generation Partnership Project (3GPP) for data collection from an environment. One goal of MDT is to enhance the performance of networks and improve user experience by optimizing the process of network measurement and data collection. One goal of MDT is to minimize the reliance on drive tests, which can be used to collect data for network optimization and troubleshooting. Drive tests involve sending personnel to physically drive around in vehicles equipped with measurement equipment to gather network performance data, which can be costly and time consuming. In an MDT framework, instead of a designated test equipment, a UE can be configured to measure various network performance indicators such as signal strength, quality, and coverage. This data can then be used by network operators to assess and improve network performance. MDT is designed to collect data both in real time and over periods of time, with the measurements being triggered by specific network events or collected periodically during regular device usage. The different modes of data collection enable operators to gather a comprehensive understanding of network conditions without deploying extensive field testing resources.

MDT procedures can involve UEs configured by the network to collect specific measurement data, which can include parameters like reference signal received power (RSRP), reference signal received quality (RSRQ), and other network performance metrics. The UE either reports the data immediately when certain predefined conditions are met or logs the data for transmission at a later time when data reporting is less likely impact user experience. Flexible data collection methods can ensure continuous monitoring of network performance, allowing operators to quickly identify and resolve issues, optimize resource allocation, and enhance overall service quality. MDT leverages the widespread availability of UEs to provide a cost-effective and efficient way to maintain and improve mobile network performance.

AI/ML models can be trained for different use cases and sub-use cases considering potential scenarios and conditions that a UE and NE may experience. In particular, for UE sided models or UE-part of two sided models, to apply AI/ML functionality for inference, a model may be located at the UE/UE side. The trained models may be owned and controlled by the chipset vendors/UE manufacturers. Alternatively, or in addition, the models can be controlled by operators, such that the models can be located on a server owned/trusted by the operator. The UEs may individually have different models available depending on the scenario/conditions compared to other UEs. For an efficient model transfer via a 3GPP network, the NE and the UE can be aligned concerning the status of the available models at the UE to ensure seamless service connectivity and continuity. Additionally, user consent and UE acknowledgment on model download can be important when considering user plane model transfer. Since the process of model provisioning by the network or model acquisition by the UE can involve coordination with the network, further challenges are to be addressed when more than one operator is involved in AI/ML model transfer and management. Therefore, considering the impact and UE behavior in the case of Dual-SIM or MUSIM can be important. Managing model transfer/download, update, and fine-tuning via user plane transmission may involve feedback from the UE which may include acknowledgement from the UE, preference on model transfer, and model availability information.

Aspects of the present disclosure include solutions for signaling for model transfer and delivery to the UE from the NE (e.g., network, UE-server, OTT-server), coordination and signaling for indicating information corresponding to models available at the UE, and model transfer and delivery in MUSIM scenarios.

Implementations include solutions for provisioning and acquiring AI/ML models at the UE. A UE can signal its support for AI/ML functionality as a UE capability to the network. Based on the UE capability and the indicated AI/ML functionalities by the UE, the UE can receive and acquire models for supported functionality. Different solutions for enabling model availability at the UE are described. In an implementation, a model can be transferred directly by a network/CN entity to the UE via control plane signaling. In another implementation, a model can be transferred to the UE via the user plane.

For model transfer via user plane, the UE can be configured to acquire a model for AI/ML functionality by initiating a request for the specific AI/ML model or a request for AI/ML functionality. The request for an AI/ML model may include functionality ID(s), and additional assistance information such as associated ID(s) for UE-side conditions, and other metadata to identify the model. In response to the UE request, the network may approve or reject the request for the model based on user authentication, model availability at the model server, associated ID(s), etc. The UE may receive additional instructions from the network or another model management entity in the CN for the UE to fetch the model e.g., a download link. Upon approval of the model request, the UE can fetch/download the AI/ML model based on the received instructions. The model can be transferred to the UE as application layer data by extending application layer security mechanisms. After downloading the model, the UE can send a fetch complete indication to the network to confirm the availability of the AI/ML models(s) at the UE. If a suitable model from the UE is not available, the network may send a rejection.

Alternatively, or in addition, the UE may send a model request for all or some of the supported AI/ML functionalities, to which the network may provide the models to the UE as and when the functionalities become available at a model server. If the UE sends a request for AI/ML model transfer with limited assistance information for model identification, it can be up to the network/model management entity to decide on the appropriate model for the UE.

Alternatively, or in addition, the network may initiate the model transfer process and perform the model transfer after receiving an acknowledgment from the UE. The network may send a request to the UE when the network determines to provide an AI/ML model or update an existing AI/ML model. The request from the network may include information such as model size, data volume, estimated transfer duration, etc. Additionally, the network can provide options to the UE to accept, reject, and/or postpone the model transfer. If the UE accepts the request from the network, the model can be transmitted to the UE from a model repository, e.g., model data storage.

Implementations can enable model transfer via a control plane. For instance, the provision of an AI/ML model can be initiated from a NE or OTT server. The network can transfer or provide an AI/ML model in different ways including via direct downlink transmission, by requesting an acknowledgment from the UE before initiating the model transfer, and by configuring the UE to initiate or request for a new model or a model update. The network can provide or update AI/ML models to the UE based on factors such as user traffic, user trajectory, environment, user mobility, etc. Model transfer can be performed via a new or existing signaling radio bearer (SRB). In an implementation, a model repository and mode management may be under network/operator control. Based on the UE capability information from the UE, the network can identify and transfer a model to the UE for each functionality. Alternatively, or in addition, the network may transfer an AI/ML model after coordinating with the UE and receiving an acknowledgment. Alternatively, or in addition, the network may configure the UE to initiate the model transfer process by requesting a new model or model update. Upon receiving the request from the UE, the network may accept or reject the model transfer request. The network may send options to the UE e.g., a model for the same functionality with different configurations. Alternatively, or in addition, the model can be transferred from an entity in the core network over NAS or other signaling.

Implementations include coordination and signaling information corresponding to AI/ML models available at the UE. For example, the network may or may not be aware of all the available models at the UE, which can cause a discrepancy during model updates or if a new model becomes available. To overcome such issues, the UE can send an indication (e.g., model availability indication) for available models at the UE to the network. Such indications can avoid re-downloading already available or updated models at the UE and the consumption of additional resources for model transfer. The model availability indication may include information about the available models at the UE such as the model ID, a version number of the available model, and associated ID(s). A UE can be configured to signal the model availability information upon network request, periodically, event-triggered, or proactively. The UE can also indicate model availability information when the UE transitions from the RRC Idle/Inactive state to the RRC Connected state or during ongoing RRC connected state (e.g., due to download with other USIM/operator). In some cases, the model availability information from the UE can be based on the NE side conditions such that model availability information can include information for models associated with the received associated ID(s) or NE side conditions.

Implementations include signaling for provisioning and acquiring AI/ML models at the UE in the case of MUSIM. Implementations described herein can be extended further when the UE is equipped with more than one SIM. An indication of model availability information can be important with the possibility of simultaneous radio connections of the UE e.g., Dual SIM from two different operators. An AI/ML model can be made available at the UE using user plane signaling in different ways, including by UE request for AI/ML model download and by network command to the UE to fetch certain AI/ML models. For both of these options, different alternatives can be considered for selecting or assigning a relevant operator to transfer the AI/ML model to the UE.

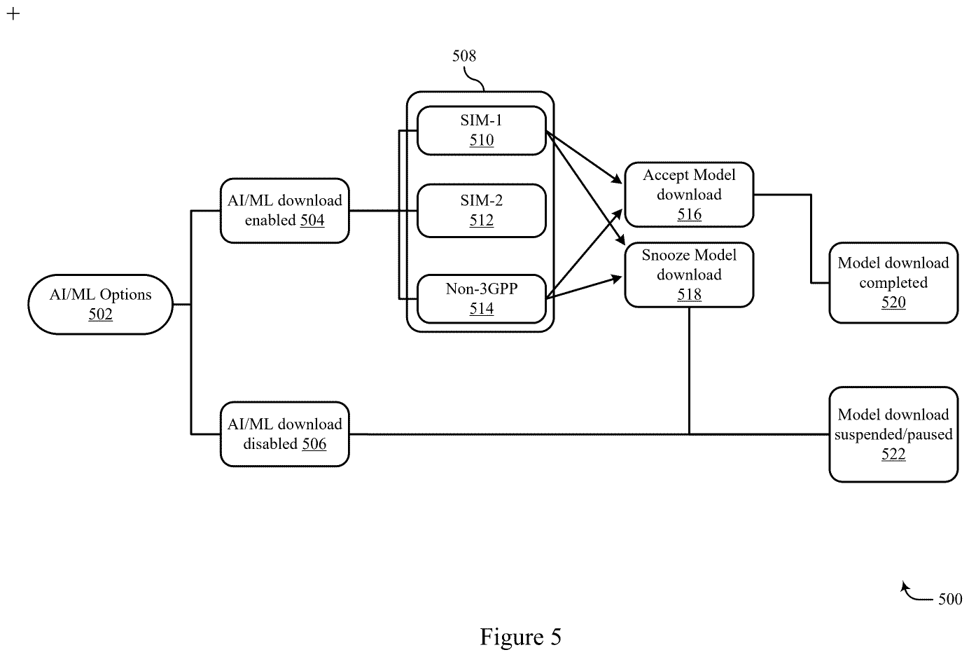

FIG. 5 illustrates an example system 500 in accordance with aspects of the present disclosure. The system 500, for example, provides different options for AI/ML-related downloads via menu settings. The system 500 includes an AI/ML options setting 502 which includes an AI/ML download enabled setting 504 and an AI/ML download disabled setting 506. Further, for the AI/ML download enabled setting 504, multiple download options 508 can be provided including a SIM option 510, a SIM option 512, and a non-3GPP option 514. The SIM options 510, 512 can represent different wireless cellular communication technologies for different operator, such as via 3GPP compliant protocols. The non-3GPP option 514 can represent other wireless communication technologies, such as WiFi, Bluetooth, satellite-based access, etc.

The system 500 also includes an accept model download option 516 and a snooze model download option 518. The accept model download option 516 can be implemented to allow model download via a respective download option 508, when available. The snooze model download option 518 can be implemented to pause model download via a respective download option 508, such as one or more of the download options 508. At 520 an indication of a completed model download can be triggered. At 522 an indication of a model download being suspended and/or paused can be triggered.

In implementations, one of the operators (e.g., one of SIM option 510, SIM option 512) can be a primary operator who is by default responsible for model transfer and/or model management for the UE. The access to models for the UE may be specified to the primary operator. For instance, a user may not select a different SIM for downloading the AI/ML models. Further, the process of model transfer/model update may be restricted to the active duration of the primary SIM (e.g., SIM option 510).

The network may configure the UE to download an AI/ML model via a particular SIM. In an example implementation, the UE follows the instructions from the network to download a model if the recommended SIM is active or becomes active. Alternatively, if the SIM configured for model download is not one of the active SIMs, the model download can be paused/suspended or reconfigured by the network. In another example implementation, the UE may accept or reject the request for model download based on the options provided by the network. Alternatively, or in addition, the UE may respond with a request to reschedule the model download to a later time, e.g., snooze model download by N number of hours/days. In yet another implementation, the model can be downloaded via a non-3GPP network such as WiFi connectivity, which can be either up to network configuration or user choice.

In another example implementation, one of the registered SIMs can be selected for downloading an AI/ML model. It can be up to the UE (e.g., user) to choose the data connection of a network operator of choice for downloading specific AI/ML models. In the case of Dual SIM Dual Standby (DSDS), while two SIMs are configured and active, only one SIM may be active at a time for data transmission. Upon receiving a request to fetch the AI/ML model, the user can select to download it over the existing active SIM or schedule a download over the secondary SIM. Based on user response, the UE can send a response to the network indicating model download status. Whereas, in the case of Dual SIM Dual Active (DSDA) in which two SIMs are configured and simultaneously active for data service, the user can select from a SIM from multiple SIMs for model download based on the user preference set.

Alternatively, or in addition, when the user switches from one SIM (SIM option 510) to another (SIM option 512) or due to more than one SIM being active simultaneously, the model availability information can be indicated to the network of other SIMs. This can assist in avoiding the UE being configured for model download/update for the existing updated models at the UE. The signaling of model availability information can be triggered based on different events, such as a network request to download/update a model, an event (e.g., preconfigured event), a change of UE RRC state, a change of UE side conditions, a change of NE side conditions, a change of active SIM, etc.

In implementations, the UE can signal model availability information via RRC signaling such as UAI in RRC Connected mode. The UE can indicate this information via UE capability information, e.g., when UE was not in RRC connected state in a network of a SIM when the model download occurred. Alternatively, or in addition, the UE may indicate the model availability information via NAS signaling to an entity in the core network. If the UE does not include a particular AI/ML model or an updated AI/ML model that can be applicable, the UE may apply a fallback (e.g., legacy or default AI/ML) scheme.

In implementations, the UE can autonomously download (or schedule a download) of a model through the non-GPP connection (e.g., WiFi), e.g., when the model availability is not controlled by the operator. The operator can also facilitate the download of the model through trusted or non-trusted non-GPP access based on user/operator reference to avoid the 3GPP radio resources. This decision can be based on user preference, network loading, network radio conditions, etc.

In some cases, the UE side can manage AI/ML models independently, while the storage location of the models can be controlled by the UE vendor or controlled by both the UE side and the network/operator. In an example implementation, the UE side can manage and store the AI/ML models and perform model transfer to the UE via the 3GPP network by exchanging information with the network e.g., by requesting the network to transfer a particular model, where the request may include model identifiers and metadata of the model.

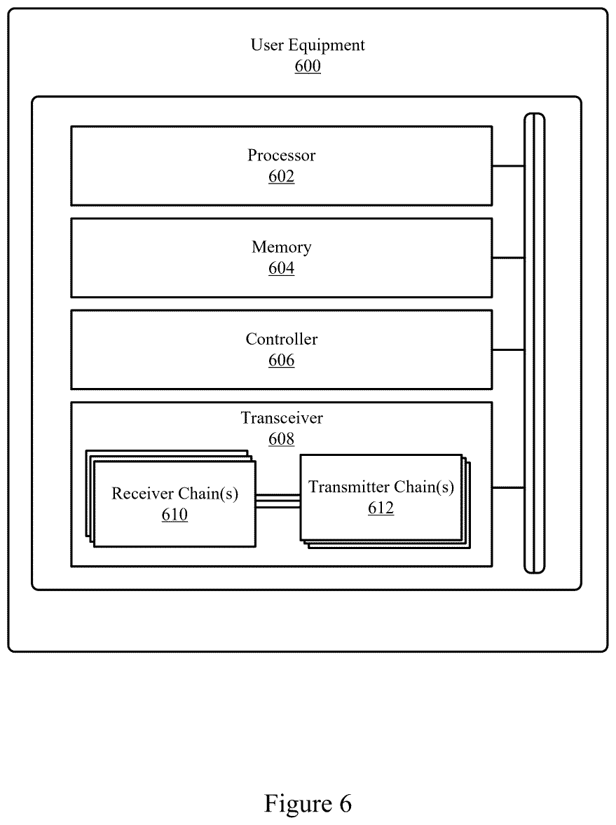

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for generating an indication associated with an AI/ML model, where the indication includes information of AI/ML model functionality available at the UE; and transmitting the indication associated with the AI/ML model.

Additionally, the UE 600 may be configured to support any one or combination of where the indication is transmitted based at least in part on a request for AI/ML functionality of the UE; the indication is transmitted based at least in part on a SIM status of the UE, where the SIM status corresponds to a change in an active SIM from a first SIM of the UE to a second SIM of the UE; the indication is transmitted based at least in part on a change in RRC state; the indication is transmitted via a RRC message; the indication is transmitted via UAI.

Additionally, or alternatively, the UE 600 may support at least one memory (e.g., the memory 604) and at least one processor (e.g., the processor 602) coupled with the at least one memory and configured to cause the UE to generate an indication associated with an AI/ML model, where the indication includes information of AI/ML model functionality available at the UE; and transmit the indication associated with the AI/ML model.

Additionally, the UE 600 may be configured to support any one or combination of where the indication is transmitted based at least in part on a request for AI/ML functionality of the UE; the indication is transmitted based at least in part on a SIM status of the UE, where the SIM status corresponds to a change in an active SIM from a first SIM of the UE to a second SIM of the UE; the indication is transmitted based at least in part on a change in RRC state; the indication is transmitted via a RRC message; the indication is transmitted via UAI.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for generating an indication associated with AI/ML model transfer, where the indication includes information of one or more AI/ML model transfer settings of the UE; and transmitting the indication associated with the AI/ML model transfer.

Additionally, the UE 600 may be configured to support any one or combination of where the indication is transmitted based at least in part on a request for the one or more AI/ML model transfer settings of the UE; the request includes options to accept AI/ML model transfer, reject AI/ML model transfer, or suspend AI/ML model transfer; the indication includes an indication to accept AI/ML model transfer, and further including receiving an AI/ML model transfer configuration; the one or more AI/ML model transfer settings include an indication of one or more connection types for AI/ML model transfer to the UE; the indication of the one or more connection types includes an indication to use, for AI/ML model transfer to the UE, one of a first SIM connection, a second SIM connection, or a non-3GPP wireless connection; the indication is transmitted based at least in part on one or more of: a configuration associated with AI/ML model transfer; a SIM status of the UE, where the SIM status corresponds to a change in an active SIM from a first SIM of the UE to a second SIM of the UE; or a change in RRC state.

Additionally, or alternatively, the UE 600 may support at least one memory (e.g., the memory 604) and at least one processor (e.g., the processor 602) coupled with the at least one memory and configured to cause the UE to generate an indication associated with AI/ML model transfer, where the indication includes information of one or more AI/ML model transfer settings of the UE; and transmit the indication associated with the AI/ML model transfer.

Additionally, the UE 600 may be configured to support any one or combination of where the indication is transmitted based at least in part on a request for the one or more AI/ML model transfer settings of the UE; the request includes options to accept AI/ML model transfer, reject AI/ML model transfer, or suspend AI/ML model transfer; the indication includes an indication to accept AI/ML model transfer, and where the at least one processor is configured to cause the UE to: receive an AI/ML model transfer configuration; the one or more AI/ML model transfer settings include an indication of one or more connection types for AI/ML model transfer to the UE; the indication of the one or more connection types includes an indication to use, for AI/ML model transfer to the UE, one of a first SIM connection, a second SIM connection, or a non-3GPP wireless connection; the indication is transmitted based at least in part on one or more of: a configuration associated with AI/ML model transfer; a SIM status of the UE, where the SIM status corresponds to a change in an active SIM from a first SIM of the UE to a second SIM of the UE; or a change in RRC state.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

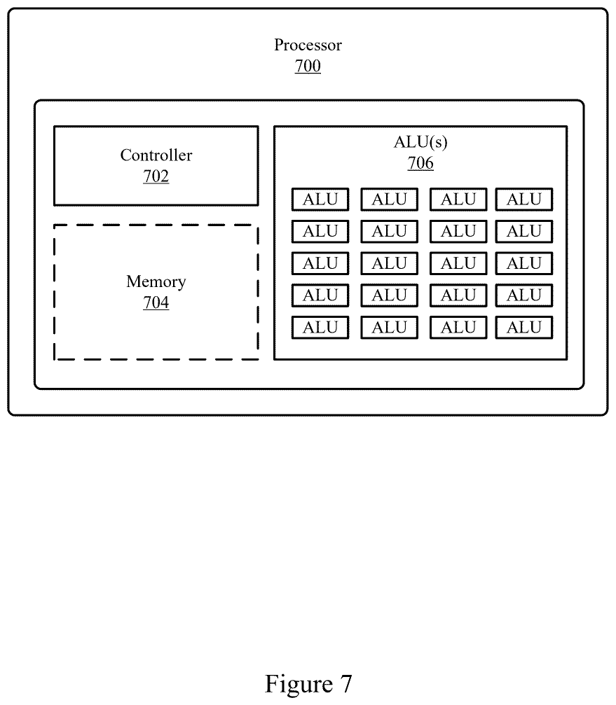

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to generate an indication associated with an AI/ML model, where the indication includes information of AI/ML model functionality available at a UE; and transmit the indication associated with the AI/ML model.

Additionally, the processor 700 may be configured to or operable to support any one or combination of where the indication is transmitted based at least in part on a request for AI/ML functionality of the UE; the indication is transmitted based at least in part on a SIM status of the UE, where the SIM status corresponds to a change in an active SIM from a first SIM of the UE to a second SIM of the UE; the indication is transmitted based at least in part on a change in RRC state; the indication is transmitted via a RRC message; the indication is transmitted via UAI.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to generate an indication associated with AI/ML model transfer, where the indication includes information of one or more AI/ML model transfer settings of the UE; and transmit the indication associated with the AI/ML model transfer.

Additionally, the processor 700 may be configured to or operable to support any one or combination of where the indication is transmitted based at least in part on a request for the one or more AI/ML model transfer settings of the UE; the request includes options to accept AI/ML model transfer, reject AI/ML model transfer, or suspend AI/ML model transfer; the indication includes an indication to accept AI/ML model transfer, and where the at least one controller is configured to cause the processor to: receive an AI/ML model transfer configuration; the one or more AI/ML model transfer settings include an indication of one or more connection types for AI/ML model transfer to the UE; the indication of the one or more connection types includes an indication to use, for AI/ML model transfer to the UE, one of a first SIM connection, a second SIM connection, or a non-3GPP wireless connection; the indication is transmitted based at least in part on one or more of: a configuration associated with AI/ML model transfer; a SIM status of the UE, where the SIM status corresponds to a change in an active SIM from a first SIM of the UE to a second SIM of the UE; or a change in RRC state.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit a request for one or more AI/ML model transfer settings of a UE; and receive an indication associated with AI/ML model transfer, where the indication includes the one or more AI/ML model transfer settings of the UE.

Additionally, the processor 700 may be configured to or operable to support any one or combination of where the request includes options to accept AI/ML model transfer, reject AI/ML model transfer, or suspend AI/ML model transfer; the indication includes one of a first setting to accept AI/ML model transfer, a second setting to reject AI/ML model transfer, or a third setting to suspend AI/ML model transfer; the indication includes a first setting to accept AI/ML model transfer, and where the at least one controller is configured to cause the processor to: transmit a notification configured to enable the UE to obtain one or more AI/ML models, where the notification includes one or more of: the one or more AI/ML models; or an instruction for obtaining the one or more AI/ML models; the notification is transmitted via one of control plane signaling or user plane signaling; the one or more AI/ML model transfer settings include an indication of one or more connection types for AI/ML model transfer to the UE; and the indication of the one or more connection types includes an indication to use, for AI/ML model transfer to the UE, one of a first SIM connection, a second SIM connection, or a non-3GPP connection, where the notification is transmitted via a connection type of the one or more connection types.

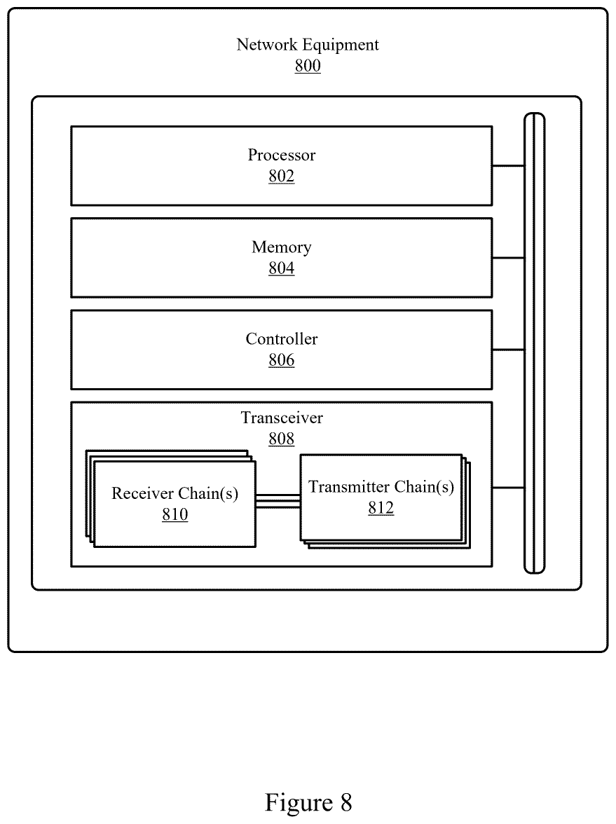

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting a request for one or more AI/ML model transfer settings of a UE; and receiving an indication associated with AI/ML model transfer, where the indication includes the one or more AI/ML model transfer settings of the UE.

Additionally, the NE 800 may be configured to or operable to support any one or combination of where the request includes options to accept AI/ML model transfer, reject AI/ML model transfer, or suspend AI/ML model transfer; the indication includes one of a first setting to accept AI/ML model transfer, a second setting to reject AI/ML model transfer, or a third setting to suspend AI/ML model transfer; the indication includes a first setting to accept AI/ML model transfer, and further including transmitting a notification configured to enable the UE to obtain one or more AI/ML models, where the notification includes one or more of: the one or more AI/ML models; or an instruction for obtaining the one or more AI/ML models; the notification is transmitted via one of control plane signaling or user plane signaling; the one or more AI/ML model transfer settings include an indication of one or more connection types for AI/ML model transfer to the UE; and the indication of the one or more connection types includes an indication to use, for AI/ML model transfer to the UE, one of a first SIM connection, a second SIM connection, or a non-3GPP connection, where the notification is transmitted via a connection type of the one or more connection types.

Additionally, or alternatively, the NE 800 may support at least one memory (e.g., the memory 804) and at least one processor (e.g., the processor 802) coupled with the at least one memory and configured to cause the NE to transmit a request for one or more AI/ML model transfer settings of a UE; and receive an indication associated with AI/ML model transfer, where the indication includes the one or more AI/ML model transfer settings of the UE.

Additionally, the NE 800 may be configured to support any one or combination of where the request includes options to accept AI/ML model transfer, reject AI/ML model transfer, or suspend AI/ML model transfer; the indication includes one of a first setting to accept AI/ML model transfer, a second setting to reject AI/ML model transfer, or a third setting to suspend AI/ML model transfer; the indication includes a first setting to accept AI/ML model transfer, and where the at least one processor is configured to cause the NE to: transmit a notification configured to enable the UE to obtain one or more AI/ML models, where the notification includes one or more of: the one or more AI/ML models; or an instruction for obtaining the one or more AI/ML models; the notification is transmitted via one of control plane signaling or user plane signaling; the one or more AI/ML model transfer settings include an indication of one or more connection types for AI/ML model transfer to the UE; and the indication of the one or more connection types includes an indication to use, for AI/ML model transfer to the UE, one of a first SIM connection, a second SIM connection, or a non-3GPP connection, where the notification is transmitted via a connection type of the one or more connection types.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

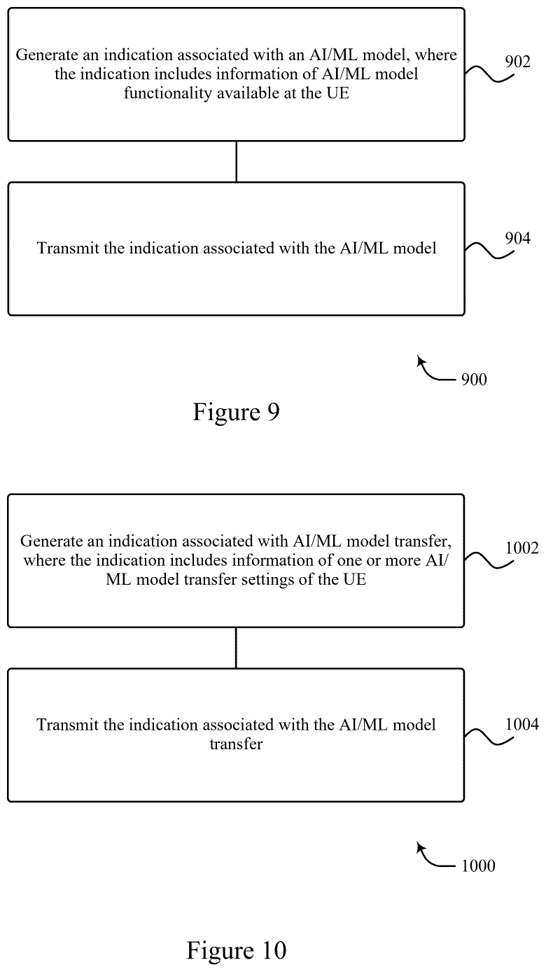

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include generating an indication associated with an AI/ML model, where the indication includes information of AI/ML model functionality available at the UE. The operations of 902 may be performed in accordance with examples as described herein. In some implementations, aspects of the operations of 902 may be performed by a UE as described with reference to FIG. 6.

At 904, the method may include transmitting the indication associated with the AI/ML model. The operations of 904 may be performed in accordance with examples as described herein. In some implementations, aspects of the operations of 904 may be performed by a UE as described with reference to FIG. 6.

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include generating an indication associated with AI/ML model transfer, where the indication includes information of one or more AI/ML model transfer settings of the UE. The operations of 1002 may be performed in accordance with examples as described herein. In some implementations, aspects of the operations of 1002 may be performed by a UE as described with reference to FIG. 6.

At 1004, the method may include transmitting the indication associated with the AI/ML model transfer. The operations of 1004 may be performed in accordance with examples as described herein. In some implementations, aspects of the operations of 1004 may be performed by a UE as described with reference to FIG. 6.

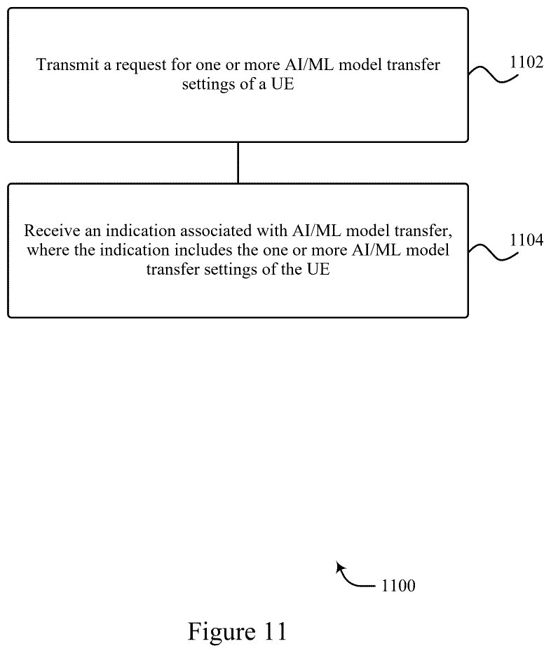

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a request for one or more AI/ML model transfer settings of a UE. The operations of 1102 may be performed in accordance with examples as described herein. In some implementations, aspects of the operations of 1102 may be performed by an NE as described with reference to FIG. 8.

At 1104, the method may include receiving an indication associated with AI/ML model transfer, where the indication includes the one or more AI/ML model transfer settings of the UE. The operations of 1104 may be performed in accordance with examples as described herein. In some implementations, aspects of the operations of 1104 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
generate an indication associated with an artificial intelligence/machine learning (AI/ML) model, wherein the indication comprises information of AI/ML model functionality available at the UE; and
transmit the indication associated with the AI/ML model.

2. The UE of claim 1, wherein the indication is transmitted based at least in part on a request for AI/ML functionality of the UE.

3. The UE of claim 1, wherein the indication is transmitted based at least in part on a Subscriber Identity Module (SIM) status of the UE, wherein the SIM status corresponds to a change in an active SIM from a first SIM of the UE to a second SIM of the UE.

4. The UE of claim 1, wherein the indication is transmitted based at least in part on a change in radio resource control (RRC) state.

5. The UE of claim 1, wherein the indication is transmitted via a radio resource control (RRC) message.

6. The UE of claim 1, wherein the indication is transmitted via UE assistance information (UAI).

7. A user equipment (UE) for wireless communication, comprising:
at least one memory; and
at least one processor coupled with the at least one memory and configured to cause the UE to:
generate an indication associated with artificial intelligence/machine learning (AI/ML) model transfer, wherein the indication comprises information of one or more AI/ML model transfer settings of the UE; and
transmit the indication associated with the AI/ML model transfer.

8. The UE of claim 7, wherein the indication is transmitted based at least in part on a request for the one or more AI/ML model transfer settings of the UE.

9. The UE of claim 8, wherein the request comprises options to accept AI/ML model transfer, reject AI/ML model transfer, or suspend AI/ML model transfer.

10. The UE of claim 7, wherein the indication comprises an indication to accept AI/ML model transfer, and wherein the at least one processor is configured to cause the UE to:
receive an AI/ML model transfer configuration.

11. The UE of claim 7, wherein the one or more AI/ML model transfer settings comprise an indication of one or more connection types for AI/ML model transfer to the UE.

12. The UE of claim 11, wherein the indication of the one or more connection types comprises an indication to use, for AI/ML model transfer to the UE, one of a first Subscriber Identity Module (SIM) connection, a second SIM connection, or a non-3GPP wireless connection.

13. The UE of claim 7, wherein the indication is transmitted based at least in part on one or more of:
a configuration associated with AI/ML model transfer;
a Subscriber Identity Module (SIM) status of the UE, wherein the SIM status corresponds to a change in an active SIM from a first SIM of the UE to a second SIM of the UE; or
a change in radio resource control (RRC) state.

14. A network equipment (NE) for wireless communication, comprising:
at least one memory; and
at least one processor coupled with the at least one memory and configured to cause the NE to:
transmit a request for one or more artificial intelligence/machine learning (AI/ML) model transfer settings of a user equipment (UE); and
receive an indication associated with AI/ML model transfer, wherein the indication comprises the one or more AI/ML model transfer settings of the UE.

15. The NE of claim 14, wherein the request comprises options to accept AI/ML model transfer, reject AI/ML model transfer, or suspend AI/ML model transfer.

16. The NE of claim 14, wherein the indication comprises one of a first setting to accept AI/ML model transfer, a second setting to reject AI/ML model transfer, or a third setting to suspend AI/ML model transfer.

17. The NE of claim 14, wherein the indication comprises a first setting to accept AI/ML model transfer, and wherein the at least one processor is configured to cause the NE to:
transmit a notification configured to enable the UE to obtain one or more AI/ML models, wherein the notification comprises one or more of:
the one or more AI/ML models; or
an instruction for obtaining the one or more AI/ML models.

18. The NE of claim 17, wherein the notification is transmitted via one of control plane signaling or user plane signaling.

19. The NE of claim 17, wherein:
the one or more AI/ML model transfer settings comprise an indication of one or more connection types for AI/ML model transfer to the UE; and
the indication of the one or more connection types comprises an indication to use, for AI/ML model transfer to the UE, one of a first Subscriber Identity Module (SIM) connection, a second SIM connection, or a non-3GPP connection,
wherein the notification is transmitted via a connection type of the one or more connection types.

20. A method performed by a user equipment (UE), the method comprising:
generating an indication associated with an artificial intelligence/machine learning (AI/ML) model, wherein the indication comprises information of AI/ML model functionality available at the UE; and
transmitting the indication associated with the AI/ML model.
